(19) United States
(12) Patent Application Publication
(10) Pub. No.: US 2006/0143511 A1
(43) Pub. Date: Jun. 29, 2006

(54) Memory mapped spin lock controller

(76) Inventor: Louis D. Huemiller JR., San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/027,159

(22) Filed: Dec. 29, 2004

(51) Int. Cl. G06F 11/00

(52) U.S. Cl. 714/12

(57) ABSTRACT

A method, in a computer system having a centralized spin lock controller arrangement, for managing a spin lock between a first processor and a second processor. The first processor holds the spin lock, the second processor contends for the spin lock, and the spin lock is implemented using a line of memory. The method includes invalidating a first private copy of the line that is held by the first processor. The method further includes providing a second private copy of the line to the second processor even before the first processor releases the spin lock, thereby preventing the second processor from requesting for a private copy of the line again while the spin lock is still held by the first processor.

### BACKGROUND OF THE INVENTION

In a multi-processing system, there will be times when multiple processes wish to atomically access a given block of memory. As an example, multiple processes may wish to perform an operation commonly known as a read-modify-write sequence. During a read-modify-write sequence, a value is read from a given block of memory by a process, manipulated in a process specific manner, and then either the original value is left unmodified or the result of the manipulation is written over top of the original value.

A block of memory, in the sequential memory model, may be viewed as a contiguous chunk of memory. Atomic access means that once the reading or writing is begun by a CPU, such reading or writing cannot be interrupted or interfered with by any other memory operation to the same block of memory, such as from any other CPU or I/O device, on the system. When multiple CPUs attempt to write (or update) to the same block of memory, a potential for conflict arises. For this reason, some arbitrating mechanism is often employed to allow sequential access to the desired block of memory.

A spin lock is a mechanism employed to control sequential access by multiple CPUs to a block of memory. The block of memory is associated with a spin lock, and the spin lock is furnished only to the one CPU with writing (or modifying) privilege at any given point in time. For example, a spin lock may be obtained by a CPU by calling the function spinlock( ), and it may be released by calling spinunlock( ). When two or more CPUs all attempt to obtain the same spin lock, all CPUs except the CPU that actually obtains the lock would spin in an idle loop waiting to obtain the spin lock. Spin locks are often used as building blocks for other types of locks, such as reader-writer locks, blocking locks, semaphores, barriers, etc.

As the spin lock is released by a CPU, one of the CPUs that was spinning waiting for the spin lock will acquire it. This will continue until all the CPUs that were spinning on the lock have successfully obtained the spin lock. Note that it is not uncommon in a busy system for at least one CPU to always be waiting to obtain a spin lock. In fact, certain spin locks may be quite popular, and at any given time, there may be multiple CPUs waiting to obtain those spin locks.

If there are multiple CPUs asking for a given spin lock, some arrangement is required to ensure that those CPUs are allowed to obtain the spin lock at some point in time. However, if the CPUs are simply allowed to compete anew each time a spin lock is released, certain inefficiency is observed. For example, when multiple spinning CPUs ask for the private copy of the memory line that contains the spin lock, those multiple spinning CPUs may be furnished copies of the line of memory when the lock is released, but only one of the spinning CPUs would, by definition, be given control of the spin lock in the next turn.

To clarify, a private copy of the line conventionally refers to the copy of the memory line that has been marked private. The marking of a memory line as private signifies that only one CPU has that private copy. In contrast, a public copy of the line refers to the copy of the memory line that has been marked public. Multiple CPUs may simultaneously hold public copies of a memory line. For cache coherence, a CPU should only modify a private copy. If the CPU needs to modify a public copy that it currently holds, it needs to cause all other public copies to be invalidated. After all other public copies are invalidated, the single remaining pubic copy held by that CPU may be marked private, thereby allowing modification to occur.

In this case, the copies of the memory line at the CPUs that did not successfully obtain the spin lock in the next turn would need to be invalidated. In doing so, bus traffic is needlessly wasted. Additionally, the time required to furnish copies of the line of memory to the CPUs that will not be given control of the spin lock, as well as the time required to invalidate those copies once the spin lock is furnished to the winning CPU, would detrimentally affect performance.

Efficiency is also a concern when a lock is held by one of the CPUs and other CPUs need to query for their turn. In this case, it is highly desirable that there be no traffic on the system bus since the cumulative effect of multiple CPUs continually querying for their turn would detrimentally affect the system bus bandwidth. Likewise, when a spin lock is not contended for, the CPU that just recently released the lock should be able to reacquire the lock without any traffic on the system bus.

Fairness is also another concern. It has been observed that the CPU that has recently obtained the spin lock tends to be more likely to obtain the spin lock again over other CPUs. For example, the CPU that has just obtained the spin lock in the last turn would be more likely to have data and/or instructions in its cache ready to operate on the block of memory associated with the lock and is therefore more likely to be able to request and quickly obtain the lock again over other CPUs that may have been attending to other tasks while spinning.

Attempts have been made in the past to minimize unnecessary bus traffic and to improve fairness while allowing multiple CPUs to access a block of memory through the spin lock mechanism. In one prior art approach, the spinning CPUs are put into a queue, e.g., a link list. When a CPU is finished with the spin lock, it transfers control of the spin lock to another CPU in accordance with some fairness algorithm.

While the prior art approach solves the fairness problem and substantially minimizes unnecessary bus traffic, the implementation of spin lock control in software introduces latency into a critical performance path. This is because, generally speaking, a software-oriented implementation tends to be less efficient than one implemented in hardware. What is desired therefore is a low-latency spin lock controller implementation that can minimize unnecessary bus traffic while allowing the CPUs to obtain the spin lock in a fair manner.

### SUMMARY OF INVENTION

The invention relates, in an embodiment, to a method, in a computer system having a centralized spin lock controller arrangement, for managing a spin lock between a first processor and a second processor. The first processor holds the spin lock, the second processor contends for the spin lock, and the spin lock is implemented using a line of memory. The method includes invalidating a first private copy of the line that is held by the first processor. The method further includes providing a second private copy of the line to the second processor even before the first processor releases the spin lock, thereby preventing the second processor from requesting for a private copy of the line again while the spin lock is still held by the first processor.

In another embodiment, the invention relates to a method, in a computer system having a centralized spin lock controller arrangement, for managing a spin lock among processors in which the spin lock is held by a first processor and the spin lock is implemented using a line of memory. The method includes providing a first private copy of the line to the first processor. The method further includes permitting the first processor to write the private copy of the line in a cache of the first processor without signaling the centralized spin lock controller arrangement that the first processor is going to write to the private copy of the line if no other processor of the plurality of processors contend for the spin lock.

In yet another embodiment, the invention relates to a method, in a computer system having a centralized spin lock controller arrangement, for managing a spin lock among contending processors and a first processor. The first processor holds the spin lock, the contending processors contend for the spin lock, and the spin lock is implemented using a line of memory. The method includes invalidating a first private copy of the line that is held by the first processor. The method further includes providing private copies of the line to the contending processors even before the first processor releases the spin lock, thereby preventing processors in the contending processors from requesting for a private copy of the line again while the spin lock is still held by the first processor.

In yet another embodiment, the invention relates to an article of manufacture including a program storage medium having computer readable code embodied therein. The computer readable code is configured to a spin lock among processors in a computer having a centralized spin lock controller arrangement. The spin lock is implemented using a line of memory. The article of manufacture includes a computer-readable code for providing a first private copy of the line to the first processor. The article of manufacture further includes a computer-readable code for permitting the first processor to write the private copy of the line in a cache of the first processor without signaling the centralized spin lock controller arrangement that the first processor is going to write to the private copy of the line if no other processor of the plurality of processors contend for the spin lock.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B show, in accordance with an embodiment of the present invention, how the memory-mapped spinlock controller handle multiple CPUs contending for control of the lock.

FIG. 2 shows, in accordance with an embodiment of the present invention, the steps with which the memory-mapped spinlock controller handles a move-in private request by a CPU.

FIG. 3 shows, in accordance with an embodiment of the present invention, the write-back with invalidate complete flow.

FIG. 4 shows, in accordance with an embodiment of the present invention, a method for managing a spin lock that is requested by a plurality of processors while being already held by a processor.

FIG. 5 shows, in accordance with an embodiment of the present invention, a method for managing a spin lock among a plurality of processors.

### DETAILED DESCRIPTION OF PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The following figures and discussions are directed toward embodiments of the memory mapped spin lock controller. In the following example, four CPUs (CPU0-CPU3) wish to have control of the lock at various times. To minimize the length of the example, the sequence will start with the lock already held by CPU1. For this example, it is assumed that a CPU employs the test-and-set instruction for locking. A test-and-set instruction is an atomic instruction that obtains the current value of the lock word and sets all the bits (F . . . F in hex). By convention, if the initial value obtained is non-zero, it is assumed that the lock is already held by another CPU. On the other hand, if the initial value obtained is zero, it is assumed the lock was not held. Since the test-and-set instruction sets the bits to all F's, the lock is thus obtained. The non-zero value of the lock word will inform other CPUs that the lock is now held.

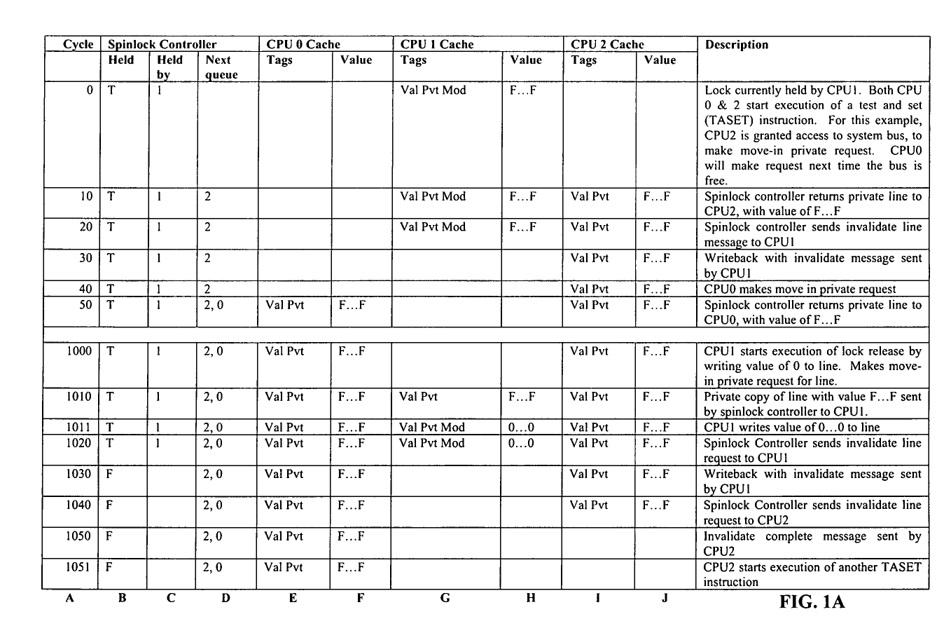

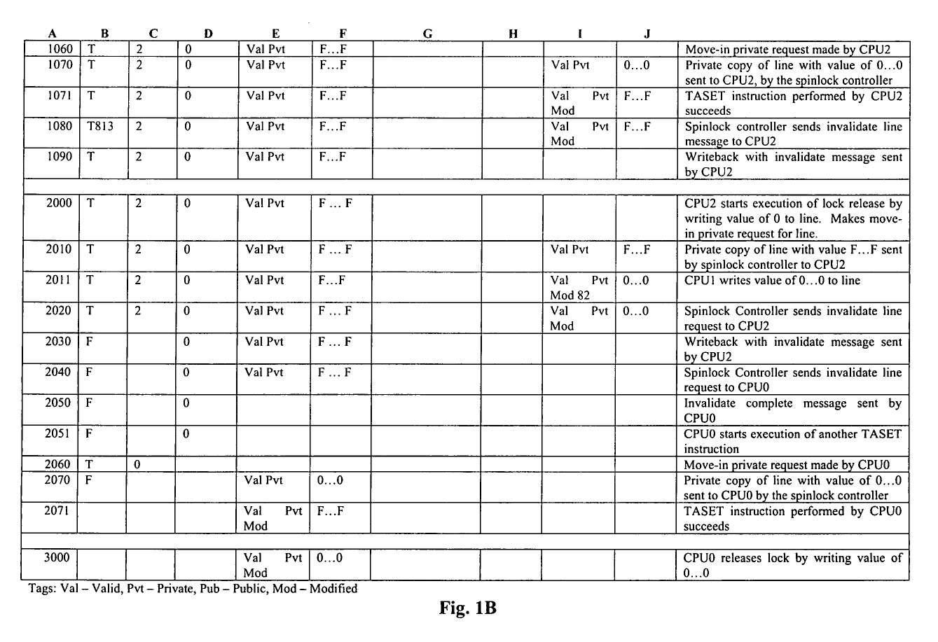

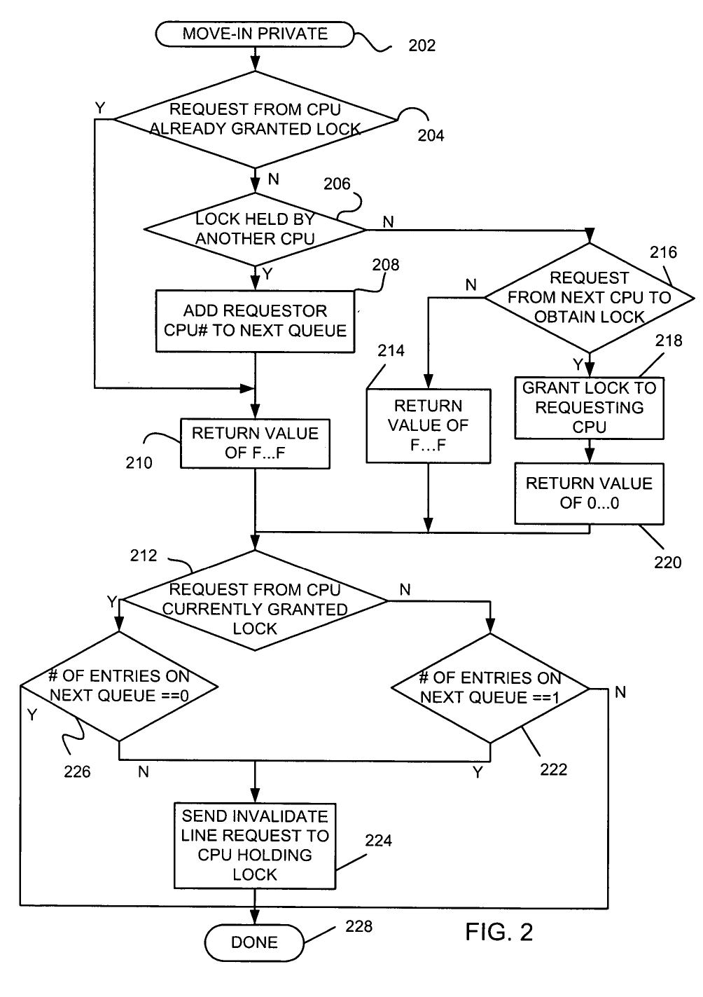

With reference to FIGS. 1A and 2, in cycle 0, the lock is held by CPU1, and both CPU0 and CPU2 start execution of the test-and-set instruction to contend for the lock. To do so, both CPU0 and CPU2 will make their move-in private requests. Since the bus can only handle one move-in private request at a time, some bus arbitration scheme is implemented. In this example, CPU2 is assumed to have a higher priority and is thus granted access to the bus first to make its move-in-private request (step 202). CPU0 will make the request the next time the bus is granted to it.

In the present example, it is assumed that the CPU executes at a much faster speed than the speed of the bus. This is typical in most systems. It is assumed herein that the CPU clock is 10 times faster than the bus clock. This is not a limitation of the invention but is done to simplify the discussion. Furthermore, it is assumed that the bus arbitration rules favor existing work over new work. Thus, if a message is solicited (i.e., in response to a previous request), it is given priority by the bus arbitration scheme over an unsolicited message (i.e., the first message in a sequence of messages). Again, this is also typical in most systems.

FIG. 2 shows the steps with which the spinlock controller handles a move-in private request by a CPU, such as CPU2. In step 204, it is ascertained that the request does not come from the CPU already granted the lock (i.e., CPU1). Future samples will show the case where the other choice of 204 is taken. This occurs when a move-in private request is made from the CPU that has already been granted the lock.

If the request does not come from the CPU already granted the lock (i.e., CPU1 as ascertained in step 204), the method proceeds to block 206 wherein it is ascertained that the lock is held by another CPU other than the requesting CPU (i.e., CPU1 currently holds the lock and the requesting CPU is CPU2). Accordingly, the method proceeds to step 208 wherein the requesting CPU CPU's number is added to the request queue. A request queue may be implemented on a temporal basis (i.e., first in first served/out). A request may also be implemented based on process priority, fairness pattern, etc. In the present example, CPU2 will be added to the queue. This is shown in grid 10D in cycle 10 in FIG. 1A.

The spinlock controller then arbitrates for the bus to return the private line to CPU2, with a value of all F's (step 210). This is shown in grids 10I and 10J of FIG. 1A. In step 212, it is ascertained that the request does not come from the CPU already granted the lock (i.e., CPU2 makes the request but CPU1 is currently granted the lock). Accordingly, the method proceeds to step 222, wherein it is ascertained that the number of entry on the “next” queue is 1 (i.e., there is only one item in grid 10D). Accordingly, the method proceeds to step 224, wherein the spinlock controller sends the invalidate line request to the CPU that holds the lock. This sending is performed the next time the spinlock controller is granted the bus.

In cycle 20, the spinlock controller sends the invalidate line message to CPU1, in accordance with step 224. When CPU1 receives an invalidate line request from the spinlock controller, since the tag in CPU1 cache indicates that the line has been modified (grid 20G MOD flag) at the time the invalidate line request is received, CPU1 cannot simply throw the line away. It needs to write the line back to memory.

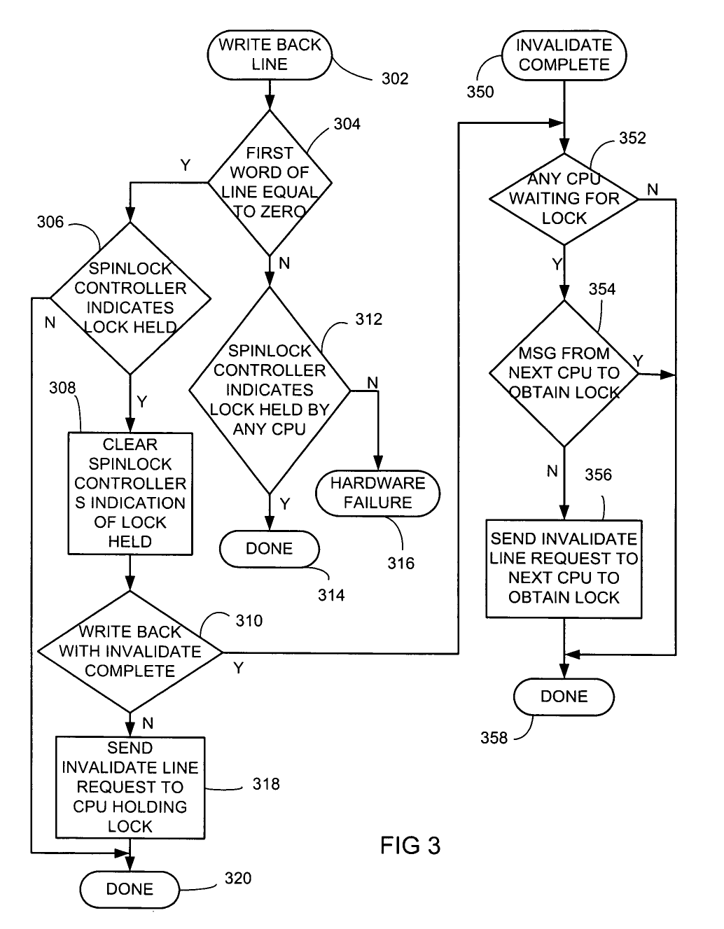

The write-back with invalidate complete flow is shown in FIG. 3. In step 304, it is ascertained that the line contains all F's (shown in grid 20H) and thus the first word of the line is not equal to zero. The method proceeds to 312, wherein it is ascertained that the lock is currently held (as shown by grid 20B). Thus the method proceeds to block 314, completing the write-back with invalidate complete message by CPU1.

In cycle 30, this completion is shown in grids 30G and 30H, indicating that CPU1 has flushed the data from its cache. At this point, CPU1 no longer needs to arbitrate for the bus, and the bus arbitration logic determines that new work can be handled. Thus CPU0 is granted the bus and can now make its move-in private request (cycle 40).

With reference to FIG. 2, CPU0 will make its move-in-private request (step 202). In step 204, it is ascertained that the request does not come from the CPU already granted the lock (i.e., does not come from CPU1). Thus, the method proceeds to block 206, wherein it is ascertained that the lock is held by another CPU other than the requesting CPU (i.e., CPU1 currently holds the lock and the requesting CPU is CPU0). Accordingly, the method proceeds to step 208 wherein the requesting CPU's number is added to the queue. In this case, CPU0 will be added to the queue. This is shown in grid 50D in the next cycle 50 in FIG. 1A.

The spinlock controller then arbitrates for the bus to return the private line to CPU0, with a value of all F's (step 210). This is shown in grids 50E and 50F of FIG. 1A. In step 212, it is ascertained that the request does not come from the CPU already granted the lock (i.e., CPU0 made the request but CPU1 is currently granted the lock). Accordingly, the method proceeds to step 222, wherein it is ascertained that the number of entry on the “next” queue is not 1 (i.e., there are two items in grid 50D). Accordingly, the method proceeds to step 228, where the flow for making the move-in private request by CPU0 is finished.

At this point, CPU0 and CPU2 both believe themselves to have a private copy. Accordingly, they do not need to continually try to arbitrate for the bus to obtain a private copy. In fact, they will operate on their private copies, believing that each is the only CPU that has the private copy. This is one way that the invention prevents CPUs which are contending for the lock from continually taking up bus bandwidth with their move-in private requests.

Meanwhile, the CPU that actually has the private copy (according to the spinlock controller logic and as shown by grid 50C) will continue to perform its work on its private copy. At some point in the future (shown as CPU cycle 1000 to facilitate discussion), CPU1 is finished with its work and starts the execution of lock release by writing all zero's to the line. However, since the line was invalidated earlier in the cache of CPU1 (see grids 30G and 30H as well as 1000G and 1000H) since it was contended for by at least CPU2, CPU1 needs to obtain the line again. Accordingly, CPU1 needs to make a move-in private request for the line.

Note that if the line was not contended for, then there is no need to invalidate the line (as was done after cycle 20 by CPU1), and there would be no need to obtain the line again for the purpose of writing all 1's to the line to release the line.

With reference to FIG. 2, CPU1 will make its move-in-private request (step 202). In step 204, it is ascertained that the request does indeed come from the CPU already granted the lock (i.e., CPU1). Thus, the method proceeds to block 210, wherein the value of all F's is sent to CPU1 by the spinlock controller. This is shown in grids 1010G and 1010H of FIG. 1A. In step 212, it is ascertained that the request does indeed come from the CPU already granted the lock (i.e., CPU1 made the request and CPU1 is currently granted the lock). Accordingly, the method proceeds to step 226, wherein it is ascertained that the number of entry on the “next” queue is not 0 (i.e., there are two items in grid 1010D). Accordingly, the method proceeds to step 224, wherein the spinlock controller sends the invalidate line request to the CPU that holds the lock the next time the spinlock controller is granted the bus.

This is because when there are other CPUs contending for the line, the method does not allow the CPU currently holding the lock to hold on to the line (and causes the other contending locks to continually asks for the line by sending move-in private requests to the bus).

As soon as CPU1 receives the line with the value of all F's, it immediately writes zeros into the line in order to release the line (since CPU1 is finished with the line and has successfully obtained the line for the purpose of writing all 0's to release the line). Since this is a CPU operation, only one CPU cycle is consumed and the result is shown in cycle 1011 (in grids 1011G and 1011H).

In cycle 1020, the spinlock controller is granted the bus to send the invalidate line message to CPU1, in accordance with step 224.

When CPU1 receives an invalidate line request from the spinlock controller (sent out earlier in cycle 1020), since the tag in CPU1 cache indicates that the line is modified (grid 1011G) at the time the invalidate line request is received, CPU1 cannot simply throw the line away. It needs to write the line back to memory.

The write-back with invalidate complete flow is shown in FIG. 3. In step 302, it is ascertained that the line contains all 0's (shown in grid 1020H) and thus the first word of the line is equal to zero. The method proceeds to 306, wherein it is ascertained that the lock is currently held (as shown by grid 1020B). Thus the method proceeds to block 308 to clear the spinlock controller of the “lock held” indication. This is shown in grid 1030B, showing the change from the “held” value in grid 1020B to the “not held” value in grid 1030B (the value in grid 1030C is immaterial once the lock is indicated as “not held”).

Since CPU1 also sends an invalidate complete message (it is responding to an invalidate line request), the method proceeds from block 310 to block 352. In block 352, it is ascertained that there are other CPUs waiting for the lock (see grid 1020D). Thus the method proceeds to block 354 wherein it is ascertained that the invalidate complete message comes from CPU1, which is not the next CPU to obtain the lock (since the next CPU to obtain the lock is CPU2 according to grid 1020D). Accordingly, the method proceeds to step 356 to send an invalidate request to the next CPU to obtain the lock (i.e., to CPU2). The method ends at step 358.

In cycle 1040, the spinlock controller is granted the bus to send the invalidate line message to CPU2, in accordance with step 356.

In cycle 1050, CPU2 receives the invalidate line message and notes that the line has not been modified. Accordingly, there is no need to write back the data and CPU2 simply clears its cache (shown by grids 1050I and 1050J) and responds with an invalidate complete message.

The sequence for the invalidate complete message without write back starts at label 350 in FIG. 3. In block 352, it is ascertained that there are other CPUs waiting for the lock (see grid 1050D). Thus the method proceeds to block 354 wherein it is ascertained that the invalidate complete message comes from CPU2, which is the next CPU to obtain the lock (since the next CPU to obtain the lock is CPU2 according to grid 1050D). Accordingly, the method proceeds to step 358, representing the end of the current flow.

Immediately after CPU2 sends the invalidate complete message, the next test-and-set operation performed in the next CPU cycle (cycle 1051) results in a cache miss (since the cache of CPU2 is cleared as discussed earlier). Accordingly, CPU2 will need to make a move-in private request. CPU2 will arbitrate for the bus, and is granted the bus to make its move-in private request in the next bus cycle (i.e., CPU cycle 1060).

Note that during the entire time that CPU2 does not have the lock, CPU2 is in its own internal loop performing test-and-set on the line in its cache that has the value of all F's. Since CPU2 has a private copy of the line, there is no cause for CPU2 to go out to the bus in order to perform a move-in private request (which would have wasted bus bandwidth). The move-in private request by CPU2 occurs now because of the invalidation that occurs due to step 356.

With reference to FIG. 2, CPU2 will make its move-in-private request (step 202). In step 204, it is ascertained that the request does not come from the CPU already granted the lock (since CPU2 does not have the lock currently per grid 1051B). Thus, the method proceeds to block 206, wherein it is ascertained that the lock is not held by any other CPU. In fact, none of the CPUs is currently granted the lock (as shown in grid 1051B). Accordingly, the method proceeds to step 216 wherein it is ascertained that the move-in private request comes from the CPU to obtain the lock next (as indicated in grid 1051D). In step 218, the lock is granted to the requesting CPU, i.e., CPU2 in this case. This granting is shown in grids 1060B and 1060C in FIG. 1B. Furthermore, CPU2 is no longer the CPU to be granted next, and thus CPU2 is taken off the “next” list. This is reflected in grid 1060D.

In step 220, the value of all zeros is returned by the spinlock controller to CPU2. This is in order to allow CPU2 to later change the value of the lock to all F's. The sending of all zeros to CPU2 is accomplished at the next bus cycle, i.e., cycle 1070 in FIG. 1B and specifically reflected in grids 1070I and 1070J. Once CPU2 receives this value of all zeros, the next test-and-set by CPU2 at CPU cycle 1071 will succeed, causing the values to change to all F's (grids 1071I and 1071J).

In step 212, it is ascertained that the request comes from the CPU already granted the lock (since CPU2 is granted the lock in step 218). Accordingly, the method proceeds to step 226, wherein it is ascertained that the number of CPUs waiting for the lock is not zero (i.e., there is one CPU, CPU0, still waiting for the lock). The method then proceeds to block 224 to send the invalidate line request to the CPU holding the lock, i.e., CPU2. The flow ends at step 228.

The sending of the invalidate line request to CPU2 is accomplished at the next bus cycle, i.e., cycle 1080 in FIG. 1B. When CPU2 receives an invalidate line request from the spinlock controller (sent out in cycle 1080), since the tag in CPU2 cache indicates that the line is modified (grid 10711) at the time the invalidate line request is received, CPU2 cannot simply throw the line away. It needs to write the line back to memory.

The write-back with invalidate complete flow is shown in FIG. 3. In step 302, it is ascertained that the line contains all F's (shown in grid 1080J) and thus the first word of the line is not equal to zero. The method proceeds to 312, it is ascertained that the lock is currently held (as shown by grid 1080B). Thus the method proceeds to block 314, completing the write-back with invalidate complete message by CPU2.

In cycle 1090, this completion is shown in grids 1090I and 1090J, indicating that CPU2 no longer has the data in its cache.

At some point in the future (shown as CPU cycle 2000 to facilitate discussion), CPU2 is finished with its work and starts the execution of lock release by writing all zero's to the line. However, since the line was invalidated earlier in the cache of CPU2 (see grids 1090I and 1090J) since it was contended for by CPU0, CPU3 needs to obtain the line again. Accordingly, CPU2 needs to make a move-in private request for the line.

Note that if the line was not contended for, then the move-in private sequence would not have executed block 224, which causes the line to be invalidated. Unless the line is invalidated for lack of data cache, the line would still be in the cache of the CPU that has the lock.

With reference to FIG. 2, CPU2 will make its move-in-private request (step 202). In step 204, it is ascertained that the request does indeed come from the CPU already granted the lock (i.e., CPU2 as reflected in grid 1090B and 1090C). Thus, the method proceeds to block 210, wherein the value of all F's is sent to CPU2 by the spinlock controller. This is shown in grids 2010I and 2010J of FIG. 1B. In step 212, it is ascertained that the request does indeed come from the CPU already granted the lock (i.e., CPU2 makes the request and CPU2 is currently granted the lock). Accordingly, the method proceeds to step 226, wherein it is ascertained that the number of entry on the “next” queue is not 0 (i.e., there is one item, CPU0, in grid 2010D). Accordingly, the method proceeds to step 224, wherein the spinlock controller sends the invalidate line request to the CPU holds the lock (CPU2) the next time the spinlock controller is granted the bus. This is because when there is another CPU contending for the line, the method does not allow the CPU currently holding the lock to hold on to the line (and causes the other contending lock to continually asks for the line by sending move-in private requests to the bus).

As soon as CPU2 receives the line with the value of all F's, it immediately writes zeros into the line in order to release the lock. Since this is a CPU operation, only one CPU cycle is consumed and the result is shown in cycle 2011 (in grids 2011I and 2011J).

In cycle 2020, the spinlock controller is granted the bus to send the invalidate line message to CPU2, in accordance with step 224. The flow ends at step 228.

When CPU2 receives an invalidate line request from the spinlock controller (sent out in cycle 2020), since the tag in CPU2 cache indicates that the line is modified (grid 2020I) at the time the invalidate line request is received, CPU2 cannot simply throw the line away. It needs to write the line back to memory.

The write-back with invalidate complete flow is shown in FIG. 3. In step 304, it is ascertained that the line contains all 0's (shown in grid 2020J) and thus the first word of the line is equal to zero. The method proceeds to 306, wherein it is ascertained that the lock is currently held (as shown by grid 2020B). Thus the method proceeds to block 308 to clear the spinlock controller of the “lock held” indication. This is shown in grid 2030B, showing the change from the “held” value in grid 2020B to the “not held” value in grid 2030B (the value in grid 2030C is immaterial once the lock is indicated as “not held”).

Since CPU2 also sends an invalidate complete message to give up the lock after writing back the value into memory, the method proceeds from block 310 to block 352. In block 352, it is ascertained that there is another CPU waiting for the lock (see grid 2020D). Thus the method proceeds to block 354 wherein it is ascertained that the invalidate complete message comes from CPU2, which is not the next CPU to obtain the lock (since the next CPU to obtain the lock is CPU0 according to grid 2020D). Accordingly, the method proceeds to step 356 to send an invalidate request to the next CPU to obtain the lock (i.e., to CPU0). The method ends at step 358.

In cycle 2040, the spinlock controller is granted the bus to send the invalidate line message to CPU0, in accordance with step 356.

In cycle 2050, CPU0 receives the invalidate line message and notes that the line has not been modified. Accordingly, there is no need to write back the data and CPU0 simply clears its cache (shown by grids 2050E and 2050F) and responds with an invalidate complete message.

The sequence for the invalidate complete message without write back starts at label 350 in FIG. 3. In block 352, it is ascertained that there is another CPU waiting for the lock (see grid 2040D). Thus the method proceeds to block 354 wherein it is ascertained that the invalidate complete message comes from CPU2, which is not the next CPU to obtain the lock (since the next CPU to obtain the lock is CPU0 according to grid 2040D). Accordingly, the method proceeds to step 356 to send an invalidate request to the next CPU to obtain the lock (i.e., to CPU0). The method ends at step 358.

In cycle 2040, the spinlock controller is granted the bus to send the invalidate line message to CPU0, in accordance with step 356.

In cycle 2050, CPU0 receives the invalidate line message and notes that the line has not been modified. Accordingly, there is no need to write back the data and CPU0 simply clears its cache (shown by grids 2050E and 2050F) and responds with an invalidate complete message.

The sequence for the invalidate complete message without write back starts at label 350 in FIG. 3. In block 352, it is ascertained that there is another CPU waiting for the lock (see grid 2050D). Thus the method proceeds to block 354 wherein it is ascertained that the invalidate complete message comes from CPU0, which is the next CPU to obtain the lock (since the next CPU to obtain the lock is CPU0 according to grid 2040D). Accordingly, the method proceeds to step 358, representing the end of the current flow.

Immediately after CPU0 sends the invalidate complete message, the next test-and-set operation performed in the next CPU cycle (cycle 2051) results in a cache miss (since the cache of CPU0 is cleared as discussed earlier). Accordingly, CPU0 will need to make a move-in private request. CPU0 will arbitrate for the bus, and is granted the bus to make its move-in private request in the next bus cycle (i.e., CPU cycle 2060).

With reference to FIG. 2, CPU0 will make its move-in-private request (step 202). In step 204, it is ascertained that the request does not come from the CPU already granted the lock (since CPU0 does not have the lock currently per grid 2050B). Thus, the method proceeds to block 206, wherein it is ascertained that the lock is not held by any other CPU. In fact, none of the CPUs is currently granted the lock (as shown in grid 2050B). Accordingly, the method proceeds to step 216 wherein it is ascertained that the move-in private request comes from the CPU to obtain the lock next (as indicated in grid 2050D). In step 218, the lock is granted to the requesting CPU, i.e., CPU0 in this case. This granting is shown in grids 2060B and 2060C in FIG. 1B. Furthermore, CPU0 is no longer the CPU to be granted next, and thus CPU0 is taken off the “next” list. This is reflected in grid 2060D.

In step 220, the value of all zeros is returned by the spinlock controller to CPU0. This is in order to allow CPU0 to later change the value of the lock to all F's. The sending of all zeros to CPU0 is accomplished at the next bus cycle, i.e., cycle 2070 in FIG. 1B and specifically reflected in grids 2070E and 2070F. Once CPU0 receives this value of all zeros, the next test-and-set by CPU0 at CPU cycle 2071 will succeed, causing the values to change to all F's (grids 2071I and 2071J).

In step 212, it is ascertained that the request comes from the CPU already granted the lock (since CPU0 is granted the lock in step 218). Accordingly, the method proceeds to step 226, wherein it is ascertained that the number of CPUs waiting for the lock is zero (i.e., there are no other CPUs waiting for the lock). The method then proceeds to step 228, ending the flow.

Note that since there are no other CPUs waiting for the lock, the line granted to CPU0 is not invalidated. Thus, in the uncontended case, there is no need for CPU0 to subsequently obtain the line from the spinlock controller in order to release it, as will be seen below.

At some point in the future (shown as CPU cycle 3000 to facilitate discussion), CPU0 is finished with its work and starts the execution of lock release by writing all zero's to the line. In cycle 3000, CPU0 writes zeros into the line in order to release the line (since CPU0 is finished with the line. The result is shown in cycle 3000.

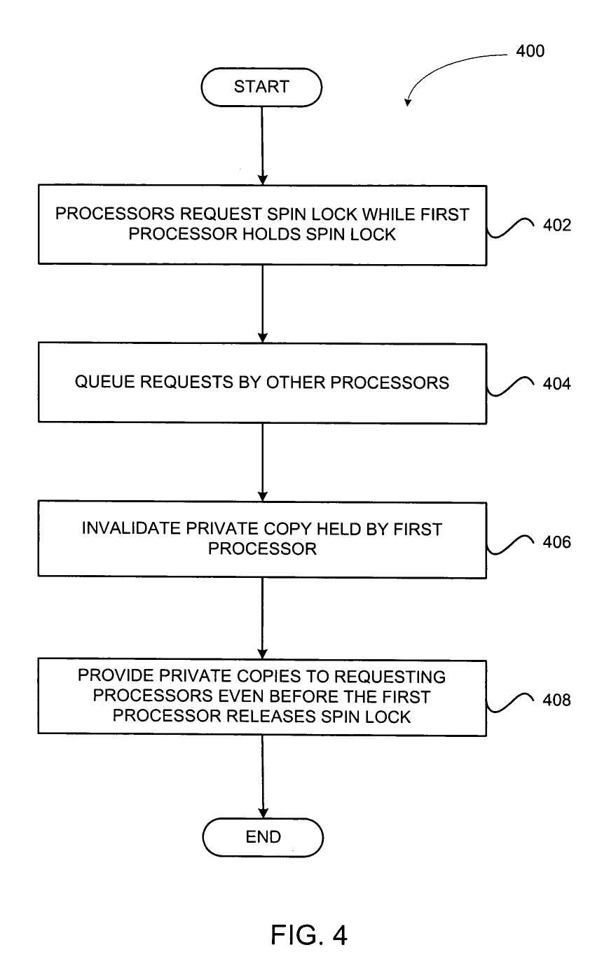

FIG. 4 shows, in accordance with an embodiment of the present invention, a method 400 for managing a spin lock that is requested by a plurality of processors while being already held by a processor (termed “the first processor” in FIG. 4). In step 402, while the first processor holds the spin lock, another processor or other processors request(s) the spin lock. In step 404, the request is queued in a request queued. In step 406, the private copy held by the first processor is invalidated. In step 408, private copies of the line are provided to the requesting processors even before the first processor releases the spin lock.

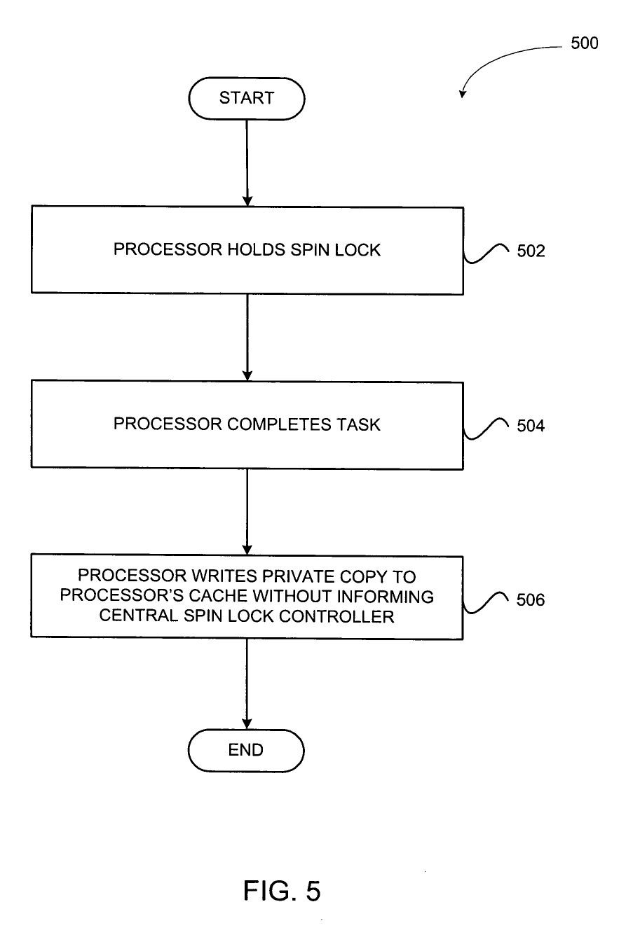

FIG. 5 shows, in accordance with an embodiment of the present invention, a method 500 for managing a spin lock among a plurality of processors. In the case of FIG. 5, a processor already has the spin lock, and after its task is finished, no other processor requests the spin lock. In step 502, it is shown that the spin lock is held by the processor. In step 504, the processor completes its task. In step 506, the processor writes a private copy to the cache of the processor without having to consume bandwidth in communicating with the central spin lock controller.

Advantages of the invention include improved efficiency and fairness. Additionally, embodiments of the invention eliminate bus traffic when a CPU is reacquiring an uncontended lock. This is in contrast to prior art centralized spin lock controller implementations whereby the CPU that reacquires an uncontended lock would need to the talk to the central controller or a non-commodity external cache. The elimination of bus traffic in such case makes it possible to use commodity processors, thereby reducing system implementation cost.

While this invention has been described in terms of several preferred embodiments, there are alterations, permutations, and equivalents which fall within the scope of this invention. For example, while the specific examples discuss the techniques in the context of spinlocks, it should be understood that the techniques disclosed herein also apply to other types of locks such as reader-writer locks, semaphores, mutexes, priority queues, etc. For example, in the case of reader-writer locks, one would expand storage of the identity of the lock holder to multiple readers and up to one writer. Similar adaptations may be made by one skilled in the art in view of the disclosure herein to enable the disclosed techniques to apply to other types of locks. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. In a computer system having a centralized spin lock controller arrangement, a method for managing a spin lock between a first processor and a second processor, said first processor holding said spin lock, said second processor contending for said spin lock, said spin lock being implemented using a line of memory, comprising:
invalidating a first private copy of said line that is held by said first processor; and
providing a second private copy of said line to said second processor even before said first processor releases said spin lock, thereby preventing said second processor from requesting for a private copy of said line again while said spin lock is still held by said first processor.

2. The method of claim 1 further comprising:
queuing a request by said second processor for said spin lock into a request queue, said queuing said request resulting in said second processor being granted said spin lock after said spin lock is released by said first processor.

3. The method of claim 2 wherein said invalidating said first private copy of said line is performed using a test-and-set procedure.

4. In a computer system having a centralized spin lock controller arrangement, a method for managing a spin lock among a plurality of processors, said spin lock being held by a first processor of said plurality of processors, said spin lock being implemented using a line of memory, comprising:
providing a first private copy of said line to said first processor; thereafter
permitting said first processor to write said private copy of said line in a cache of said first processor without signaling said centralized spin lock controller arrangement that said first processor is going to write to said private copy of said line if no other processor of said plurality of processors contends for said spin lock.

5. The method of claim 4 further comprising invalidating said first private copy of said line that is held by said first processor only if said spin lock is contended for by at least one processor other than said first processor before said first processor is finished with said private copy of said line.

6. The method of claim 4 further comprising:
receiving a request for said spin lock by a second processor of said plurality of processors;
invalidating said first private copy of said line that is held by said first processor responsive to said receiving said request; and
providing a second private copy of said line to said second processor even before said spin lock is released by said first processor.

7. The method of claim 6 further comprising:
queuing said request for said spin lock by said second processor into a request queue, said queuing said request resulting in said second processor obtaining said spin lock when said spin lock is released by said first processor.

8. The method of claim 4 wherein said first processor is configured to release said spin lock, when no other processor is contending for said spin lock, by writing a predefined value into said first private copy of said line without having to first request another private copy of said line.

9. The method of claim 7 wherein said predefined value is all zeros.

10. The method of claim 1 wherein said second processor is allowed to request over and over said spin lock while said spin lock is held by said first processor without consuming bus bandwidth of said computer system.

11. In a computer system having a centralized spin lock controller arrangement, a method for managing a spin lock among a plurality of contending processors and a first processor, said first processor holding said spin lock, said plurality of contending processors contending for said spin lock, said spin lock being implemented using a line of memory, comprising:
invalidating a first private copy of said line that is held by said first processor; and
providing private copies of said line to said plurality of contending processors even before said first processor releases said spin lock, thereby preventing processors in said plurality of contending processors from requesting for a private copy of said line again while said spin lock is still held by said first processor.

12. The method of claim 11 further comprising:
queuing requests by said plurality of processors for said spin lock into a request queue, said queuing said requests resulting in said plurality of processors being granted said spin lock over time after said spin lock is released by said first processor.

13. The method of claim 11 wherein said invalidating said first private copy employs a test-and-set procedure.

14. The method of claim 11 wherein said invalidating said first private copy includes writing a predefined value into said first private copy without having to first request another private copy of said line when no other processor is contending for said spin lock.

15. An article of manufacture comprising a program storage medium having computer readable code embodied therein, said computer readable code being configured to a spin lock among a plurality of processors in a computer having a centralized spin lock controller arrangement, said spin lock being implemented using a line of memory, comprising:
computer-readable code for providing a first private copy of said line to said first processor; thereafter
computer-readable code for permitting said first processor to write said private copy of said line in a cache of said first processor without signaling said centralized spin lock controller arrangement that said first processor is going to write to said private copy of said line if no other processor of said plurality of processors contends for said spin lock.

16. The article of manufacture of claim 15 further comprising computer-readable code for invalidating said first private copy of said line that is held by said first processor only if said spin lock is contended for by at least one processor other than said first processor before said first processor is finished with said private copy of said line.

17. The article of manufacture of claim 15 further comprising:
computer-readable code for receiving a request for said spin lock by a second processor of said plurality of processors;
computer-readable code for invalidating said first private copy of said line that is held by said first processor responsive to said receiving said request; and
computer-readable code for providing a second private copy of said line to said second processor even before said spin lock is released by said first processor.

18. The article of manufacture of claim 17 further comprising:
computer-readable code for queuing said request for said spin lock by said second processor into a request queue, said queuing said request resulting in said second processor obtaining said spin lock when said spin lock is released by said first processor.

19. The article of manufacture of claim 15 wherein said first processor is configured to release said spin lock, when no other processor is contending for said spin lock, by writing a predefined value into said first private copy of said line without having to first request another private copy of said line.

20. The article of manufacture of claim 18 wherein said predefined value is all zeros.
